(19) United States
(12) Patent Application Publication
(10) Pub. No.: US 2011/0055571 A1
(43) Pub. Date: Mar. 3, 2011

(54) METHOD AND SYSTEM FOR PREVENTING LOWER-LAYER LEVEL ATTACKS IN A NETWORK

(76) Inventor: Yoel GLUCK, San Francisco, CA (US)

(21) Appl. No.: 12/861,559

(22) Filed: Aug. 23, 2010

Related U.S. Application Data
(60) Provisional application No. 61/274,969, filed on Aug. 24, 2009.

(51) Int. Cl. H04L 9/32; G06F 21/00

(52) U.S. Cl. 713/171; 726/26

(57) ABSTRACT

A method for preventing lower-layer level attacks committed against entities in a network. The method comprises forming a secure peer group (SPG) of member entities in the network, wherein each of the member entities is configured with a media access control (MAC) address locked to its own identity and a Internet protocol (IP) address linked to its MAC address; establishing a secure handshake between at least a source member entity and a target member entity of the SPG by mutually authenticating of the source member entity and the target member entity; and securely transferring data from the source member entity to the target member entity.

### CROSS-REFERENCE TO RELATED APPLICATIONS

This application claims the benefit of U.S. Provisional Patent Application No. 61/274,969 filed on Aug. 24, 2009, the contents of which are herein incorporated by reference.

### TECHNICAL FIELD

The invention generally relates to improving the security of networks, and more specifically as a means for providing security to local area networks and transferring data within the network, in order to reduce vulnerability to attacks when using lower-layer level protocols.

### BACKGROUND OF THE INVENTION

Network security is a major concern due to the rapid growth in use of the Internet for all types of applications including those requiring high security, such as financial transactions. Although there are several ways and programs for providing security in applications, transport, or network layers of a network, there are still too many points of vulnerability within the network. One such area of vulnerability is the data link layer, also known as Layer 2 of the OSI model, in which security has not been adequately addressed in the past. Layer 2 is the layer that enables interoperability and interconnectivity of networks. Any real vulnerability in the Layer 2, which allows for attacks, is not easily detected today by the upper layers, hence can be a major security concern for the user.

Local area networks (LANs) had been considered safe until very recently and hence little effort at securing the LAN had been made. A typical LAN comprises one or more domains which are data link layer domains called Layer 2 domains. A LAN is connected to the internet by routers. Within each LAN, traffic is forwarded based on media access control (MAC) addresses. LANs typically use switches to connect between entities within a LAN. Switches are also used to link multiple Layer 2 domains within a LAN, and can also be used to link two or more LANs together. Internet traffic is routed by routers using Internet protocol (IP) addresses or other network layer addresses for transport through the Internet cloud. Within an IP network, the connectivity of the routed path is dynamic and routing takes place based on available resources and paths. In the LAN, on the other hand, the traffic is routed based on the MAC address of individual entities using IP to MAC addresses mapping information, and also mapping of MAC addresses to ports available at the switches and routers.

Typically, Ethernet devices have unique MAC addresses assigned by a central authority to ensure that no two devices have the same MAC address. Because source MAC address information is inserted into Ethernet frames during communication by the Ethernet devices, the source address in an Ethernet frame had been considered accurate and difficult to fake. In theory Ethernet MAC addresses are considered unique, at least on the same Layer 2 network, and potentially globally, any entity on a Layer 2 network can address any other entity on the network by using the MAC address assigned to the entity being addressed.

Layer 2 forwarding tables are used to connect to and send data between entities in the LAN. The Layer 2 forwarding table is normally created from header information received in Ethernet frames. This is done by storing the MAC address obtained from an Ethernet frame in a Layer 2 forwarding table, along with information identifying the port on which the frame including the header was received. Frames directed to the stored MAC address will be output via the port indicated in the Layer 2 forwarding table. Since the information in the Layer 2 (Ethernet Layer) forwarding table is obtained from Ethernet Frame headers it has been considered to be reliable.

In order to communicate over an IP network, an entity on an Ethernet LAN is required to first obtain an IP address. This has to be received from a dynamic host configuration protocol (DHCP) server. The DHCP server can be within or outside the LAN. A typical request for an IP address assumes that the request has to be transmitted through the IP network. To obtain the IP address, the entity within a LAN sends an IP address request message to a router in an Ethernet frame. In response to the request, the router populates the Layer 2 forwarding table with the MAC information obtained from the frame's header. In addition, the router acts as a proxy for the requesting entity and initiates a DHCP communications session between a DHCP server and the requesting entity. Thus, the DHCP address can have an IP address assigned to the requesting entity.

When an IP address is requested by an entity the MAC address in the header of the frame sent by the entity is not forwarded to the DHCP server. Rather, only a MAC address enclosed within the body of the information is sent. This MAC address is easy to modify and therefore is a known weakness of the system. The transmitted MAC address, included in the data field of an Ethernet frame, may be faked. The DHCP server assigns an IP address based on the communicated MAC address. The server also stores the assigned IP address, associated MAC address, and lease time information in a DHCP server database. The assigned IP address is communicated to the requesting entity, along with lease time or duration information, by way of the router. Hence, a requesting entity can falsify its MAC address, linked to the assigned IP address, stored in the database of the DHCP server. By using the MAC address of an entity within a LAN the attacking entity is able to receive and falsify information going to and coming from the real owner of the MAC address.

In existing systems, when a router connected to a LAN receives a message with an IP address which is not already in its address resolution table, the router will broadcast an address resolution protocol (ARP) message over the LAN requesting the entity which owns the IP address to respond and identify itself. Normally, the entity to which the IP address is assigned responds to the ARP message with its true MAC address. The information from the ARP message response is used to populate and update the router's address resolution table, thereby linking the IP address and the MAC address of the responding entity with the port where the response was received. Reverse address resolution request protocol (RARP) is a protocol by which a physical machine in a LAN can request to learn its IP address from a server's or router's cache. This operates the same way as the ARP but in reverse. It is easy to falsify and corrupt an address resolution table by using ARP and RARP and a faked MAC address. In such a case, the updated address resolution table of the router ends up being inconsistent with the DHCP server's database, thereby enabling attacks on the network.

Recently the attacks on the LANs have become a matter of concern, mainly due to attacks in the IP over Ethernet (Layer 2) connectivity which is today the weakest link in the security chain within the LAN. This type of attack typically happens in the case where an attacker already has access to one entity within the LAN. The attacker then attacks the network traffic by presenting itself as the owner of different MAC addresses in the LAN to divert traffic to itself. The attacker can then establish access to sniff/modify network traffic of other entities within the LAN.

It would therefore be advantageous to have a solution of securing the LAN network from attacks initiated in lower-layer level such as Layer 2, Layer 3, and Layer 4 (Ethernet Layer, IP Layer, and Transport Layer respectively). It is further advantageous to provide protection to data, in case of an attack, by ensuring that the data packets are secured by per-packet authentication.

### SUMMARY OF THE INVENTION

Certain embodiments of the invention include a method for preventing lower-layer level attacks committed against entities in a network. The method comprises forming a secure peer group (SPG) of member entities in the network, wherein each of the member entities is configured with a media access control (MAC) address locked to its own identity and a Internet protocol (IP) address linked to its MAC address; establishing a secure handshake between at least a source member entity and a target member entity of the SPG by mutually authenticating the source member entity and the target member entity; and securely transferring data from the source member entity to the target member entity.

Certain embodiments of the invention also include a system for preventing lower-layer level attacks committed against entities in a network. The system comprises a plurality of member entities connected to a network, wherein the plurality of member entities are part of a secure peer group (SPG) each of the plurality of the member entities is configured with a media access control (MAC) address locked to its respective identity and with a unique identification; a secure server for verifying legitimacy of a member entity requesting an Internet protocol (IP) address and upon verification assigning an IP address to the member entity, wherein the IP address is linked to a MAC address of the entity member; and at least a source member entity which is a member of the SPG; and at least a target member entity which is a member of the SPG, wherein the source member entity establishes a secure handshake with the target member entity and securely transfers data to the target member entity.

Certain embodiments of the invention further include a method for providing packet level security during data transfer between a source member entity and a target member entity belonging to a secure peer group (SPG). The method comprises preparing an add-on to each data packet to be transferred; combining the add-on with the data packet to form a new data packet; encrypting the new data packet using a security key belonging to the target member entity to form an encrypted new data packet; and sending the encrypted new data packet to the target member entity.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a diagram showing an exemplary and non-limiting secure LAN with MAC to IP binding in accordance with an embodiment of the invention;

FIG. 2 is a flowchart illustrating a method of the secure and mutually authenticated data transfer set up between two entities in a secure LAN in accordance with an embodiment of the invention; and

FIG. 3 is a flowchart illustrating a method of the secure packet transfer from source to target in accordance with an embodiment of the invention.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In an exemplary embodiment of the invention, a method is provided to prevent attacks on the network performed using traffic and protocols of the Layer 2 to Layer 4 of the OSI model. A secure network is established having a secure peer group (SPG) of member entities with each member entity having its media access control (MAC) address locked to its own identity. A secure server within the secure network is configured as an administrative and dynamic host configuration protocol (DHCP) server to issue IP addresses. When issuing, the identity of any requesting entity is verified and the entity is confirmed as legitimate using encrypted information transfer enabling establishment of IP address to MAC address binding for secure connectivity between members of the SPG. The security of any data transferred is further enhanced by verification of the identity of the source and target member entities and by providing per-packet authentication and encryption during data packet transport. In an embodiment of the invention, the secure network is a secure local area network (LAN).

A method implemented at various nodes of a network to prevent or limit attacks on the network that include Layer 2 to Layer 4 (Ethernet, IP and Transport Layer) attacks is disclosed. As a first step in the process, a SPG is established. For this each member entity of the SPG is given a unique identification (ID), that is backed by having the entity's identity locked to its MAC address. The unique ID is associated with an entity and may be a unique name, number, a combination thereof, or any other identifier that uniquely and distinctly identifies the entity within the secure LAN. The locking of the identity of each entity to its MAC address and establishment of the SPG with unique identification (ID) within a LAN is described in more detail in the co-pending U.S. patent application Ser. No. 12/585,586 filed on Sep. 18, 2009, “Secure Peer Group Network and Method Thereof by Locking a MAC Address to an Identity of an Entity at Physical Layer”, assigned to common assignee, and which is incorporated herein by reference for all that it contains. During the establishment of the SPG, the identity of an entity is defined by use of, for example, at least a public key of that entity. This public key is one from a pair of public and private keys generated using the public key infrastructure (PKI). Further, binding of an entity's IP and MAC address with authentication of the identity of the entity is securely established within the LAN. Techniques for performing such binding are discussed in more detail in the co-pending U.S. patent application Ser. No. 12/585,718, filed Sep. 23, 2009, “Enterprise Security Setup with Prequalified and Authenticated Peer Group Enabled for Secure DHCP and Secure ARP/RARP”, assigned to common assignee, and which is incorporated herein by reference for all that it contains.

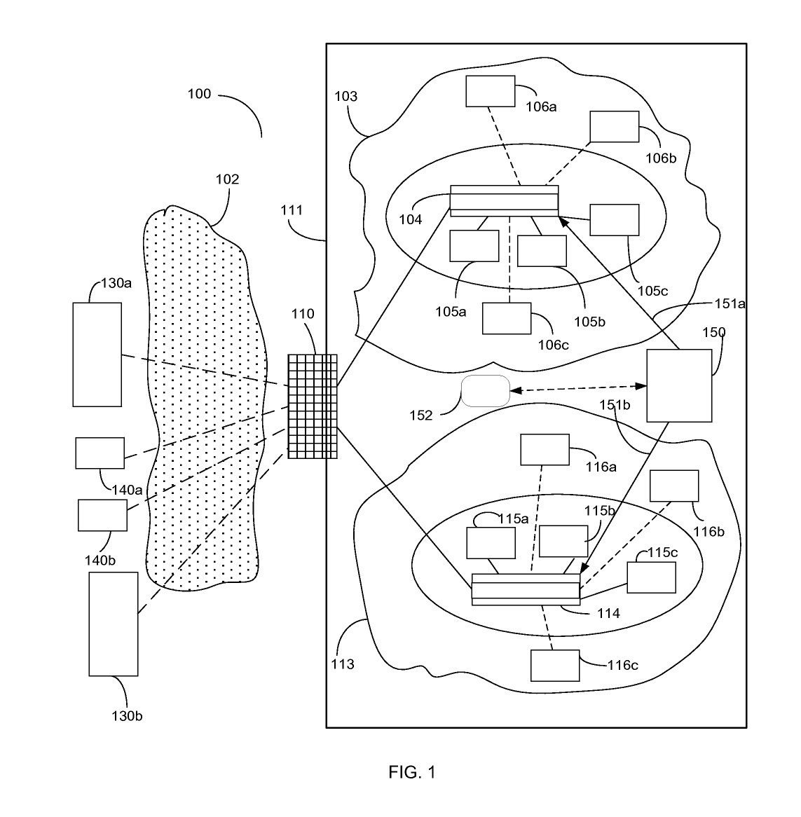

FIG. 1 shows an exemplary and non-limiting network 100 that includes a local area network (LAN) 111. In order to configure the LAN 111 as a secure LAN, a secure administrative server 150, also referred to herein as a secure server, which is also a secure dynamic host configuration protocol (DHCP) server, is provided with the security and group policies for a peer group. The entities 105, e.g., 105a to 105c, are connected by wire and entities 106, e.g., 106a to 106c, are connected by wireless to switch 104. Entities 115, e.g., 115a to 115c, are connected by wire and the entities 116, e.g., 116a to 116c, are connected by wireless to switch 114. The two switches 104 and 114 are part of the LAN 111. The secure server 150 with a storage database 152 is used as the local secure DHCP server for the LAN 111. The LAN 111 is connected to an IP network 102 by the router 110. The entities 130, e.g., 130a and 130b, and 140, e.g., 140a and 140b, are connected to the LAN via the router 110 from outside the perimeter of the LAN 111.

The LAN 111 is protected from intrusions by having its member entities, 105i, 106i, 115i, and 116i, (i-denotes any of the group of entities and may be a, b, or c), configured as a SPG with the identity of each entity linked and locked to its MAC address. The unique identity of each such an entity e.g., 105a, includes at least a public key from public key infrastructure (PKI) and a unique identity information. This qualified and verifiable peer group helps prevent any entity from identifying itself as the owner of a MAC address belonging to one of the entities in the peer group. The details of this operation are further disclosed in the co-pending U.S. application Ser. No. 12/585,586 referenced above.

The members of the LAN who are part of the SPG are then able to identify and verify the connections to other entities in the SPG, including a secure DHCP server 150. The secure DHCP server 150 provides IP addresses to the members of the LAN. This is performed with mutual authentication and verification of the legitimacy of the member entity and the secure server to be a part of the formation of the secure LAN 111. The DHCP server 150 is verified using its certificate and also its MAC address locked to its identity. The SPG membership of the requesting entity, e.g., 105a, is verified using its identification, public key and MAC address. This ensures that both the secure DHCP server 105 and the requesting entity are members of the SPG and any transaction is legitimate and protected. The data transfer can be in the encrypted form to further enhance the security. Unauthenticated packets may be discarded. Once an IP address is established, it is linked to the MAC address and identity of the entity 105a.

The network 100 is now fully protected from intrusions as any effort at connecting to members of the SPG using a non-verifiable MAC address or non-verifiable IP address is now blocked. Even in the case where the attacking entity is a legitimate entity within the SPG, it is prevented from impersonating another entity by the verifiable nature of the membership in the SPG.

Even though the connections are secure and both source entity and target entity are verifiable, further security is provided by having a packet level authentication and if necessary encryption. Since the identity of individual entities is established as part of the formation of the SPG, it is prudent to include the per packet authentication as part of the security features of the secure LAN 111.

In other embodiments of the invention, the secure LAN 111 may be any type of a communication network. For example, the secure network may be, but is not limited to, a wide area network (WAN), an enterprise network, a metro area network (MAN), and any combination thereof.

In a non-limiting and exemplary embodiment of the invention, the authentication of the two configured entities can be performed by:

verifying each other's identities in a secure manner with information exchange encrypted using public keys, thereby authenticating the source and the destination;

exchanging challenge numbers as part of the mutual authentication process between entities in encrypted form to prevent replay attacks;

verifying and binding the MAC addresses of entities for the duration of the transaction or until the time to live of the authentication process;

including authenticity information in each data packet. This information is produced by hashing a few random bytes from a psudo random number generator (PRNG) seeded by the challenge number, the data packet, and, optionally, the identity of the source member entity;

encrypting the data packets using a session key generated for the transaction or alternatively the public key of a target member entity for increased security prior to transmission to the target member entity;

decrypting the encrypted packets received by the target member entity;

verifying the authenticity of the received packets and the source member entity with the associated information; and

accepting or rejecting the received packets based on the result of the authentication.

If the authentication fails, an alert is sent to a user (e.g. a system administrator) to check if additional actions are necessary. For example, the target may optionally request a re-send of the lost data from the source member using the secure format with challenge response and encryption.

Without limiting the scope of the invention, the process of data transfer between two entities of the SPG in a secure fashion can be divided into two sections, the establishment of the authenticated connection between a source and target entities, and the secure data transfer operation.

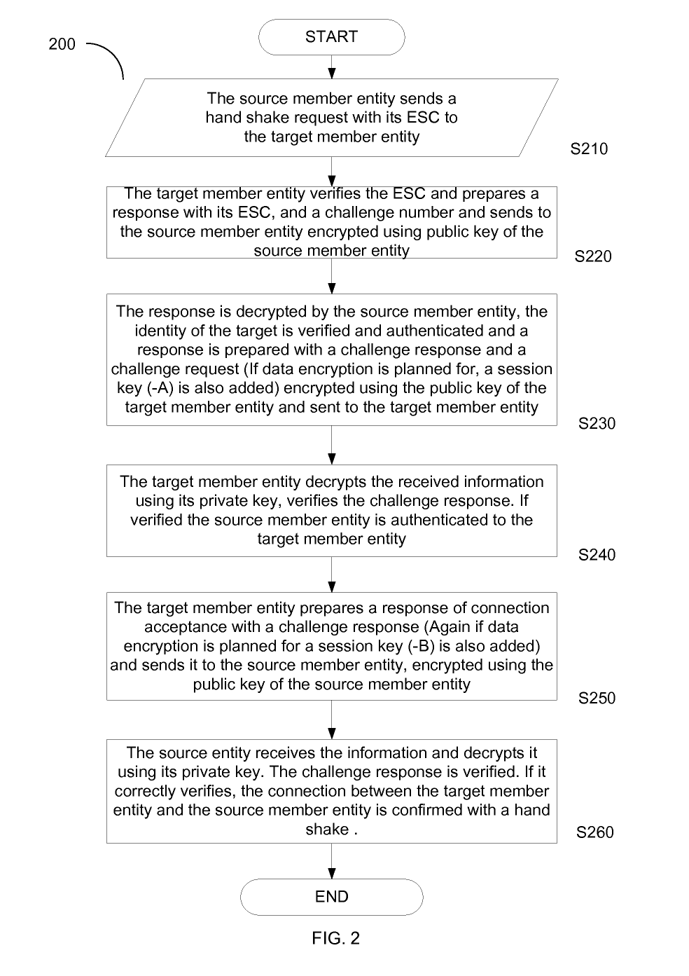

FIG. 2 shows an exemplary and non-limiting flowchart 200 illustrating a method for establishing a secure and authenticated connection between two entities for data transfer according to an embodiment of the invention.

At S210, in order to establish a secure connection and handshake between a source member entity (e.g., entity 105b) and a target member entity (e.g., entity 106a), the source member entity sends a connection request with its entity specific certificate (ESC) which includes its public key to the target member entity. At S220, the target member entity, upon receiving the request, checks the ESC and sends back a response to the request with its ESC and a challenge number (CN-1). The transmitted information is encrypted using the public key of the source member entity 105b.

At S230, the source member entity receives the response to its request, decrypts the received responses using its private key, and extracts the ESC information. The source member entity also verifies the information in the ESC of the target member entity. Once verified, the source member entity prepares a response with a challenge response (matching a challenge number CN-1) and another challenge number (CN-2). In an embodiment of the invention, if data encryption is needed, a session key (-A) is generated and included in this transmission. This is sent to the target member entity encrypted using the target member entity's public key.

At S240, the target member entity receives and decrypts the information from the source member entity. The target entity is then able to verify and authenticate the source member entity using the ESC received earlier, the challenge response enclosed in the received data, and the challenge number CN-1. At S250, the target member entity now prepares an encrypted response including the challenge response that matches the challenge number CN-2. It should be noted that if data encryption is needed, then a session key (-B) is generated and included in a response generated by the target member entity.

At S260, the source member entity decrypts the information and verifies the challenge response with the original challenge number CN-2 and target's ESC completing the mutual authentication and establishing a handshake with the target member entity. Now the two entities are ready to transfer data.

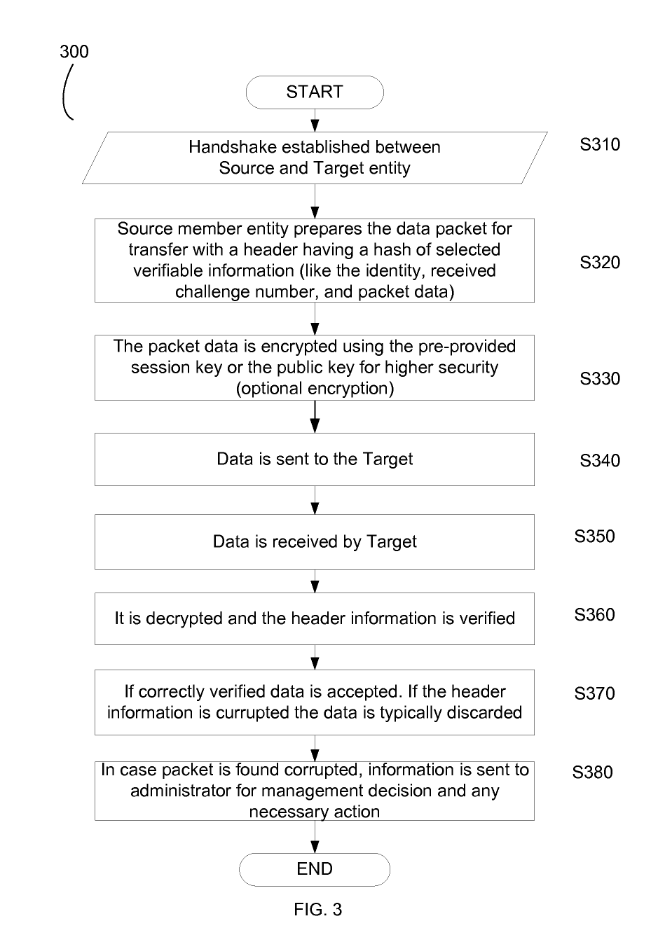

FIG. 3 shows an exemplary and non-limiting flowchart 300 illustrating a method for a secure data transfer from a source to target member entity according to an embodiment of the invention.

At S310, an indication that a secure handshake between a source and target member entity has been established, is received. At S320, the source member entity prepares the data packet with a header add-on including, but not limited to, a hash of: a few bits of the challenge number, its identity, and the data packet. The header add-on provides authentication of the source and authenticity of the packet to the target member entity. At S330, if data encryption is needed, the prepared data packet is encrypted using the previously established session key B supplied by the target member entity. It should be noted that the session key is used if speed of operation is essential and public key from a public key infrastructure is used when speed is not critical. It should be noted that the level of encryption of data packets can be preconfigured. For example, some packets may only be encrypted, signed, authenticated, or any combination thereof. Further, the encryption may be performed using encryption keys that are not provided by the target entity. For example, a group of keys or master keys can be used that can allow for additional features such as, inspection by the organization firewall, and data-leakage-prevention.

At S340, the encrypted data is now transmitted to the target member entity using an authenticated address table, stored on each member entity of the SPG, available to the source member entity. At S360, the transmitted data packet is received by the target member entity. At S360, the target member entity decrypts the received data packet using its decryption key. The target member entity further authenticates and verifies the information in the header add-on. The verification is performed using the information made available to the target member entity regarding the source member entity during mutual authentication and handshake process. This verification and authentication are performed by checking information such as the source member entity's MAC and IP addresses of the packet compared to the MAC and IP addresses authorized for the source member entity as approved in the source ESC. At S370, if the source is verified the packet is accepted. In addition, if the verification information is corrupted, the packet is stored or discarded. At S380, when the source of the packet cannot be authenticated, information of possible attack is provided to a user (e.g., an administrator) for management decision and action as needed. Optionally a request for re-transmission may be sent to the source member entity.

In certain embodiments of the invention, the header add-on can be included in the beginning, end or any other location of the data packet including in any Layer of the communication protocol, e.g., in a IP Layer (Layer 4) as data or as options in an Ethernet Layer (Layer 2) before the Ethernet header, or any other location fitted to the systems requirements. In other embodiments, the header add-on can be sent separately from the packet. For example, but without limitation, the add-on can be sent by means of a “side channel”, where the original data packet from the source to target member entity is sent as is, while the add-on is encapsulated in another packet, and transmitted thereafter to the target entity.

It should be noted that the establishment of handshake and subsequent secure data transfer processes can be combined into the ARP operation and/or the DHCP server operation each of which is described in the above referenced patent applications. It should be further noted that standard security methods used in encryption, signatures and authentication of data packets and/or users can be used instead of or in conjunction with the security teachings described herein.

It should be appreciated that by providing a packet level authentication over and above the mutual authentication of the source and target member entities as further described in the above-referenced patent application Ser. No. 12/585,718, the security of the data is increased. Using the encryption and decryption processes for packets further increases the data security when and if such security is needed.

The principles of the invention can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analog circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

What is claimed is:

1. A method for preventing lower-layer level attacks committed against entities in a network, comprising:
forming a secure peer group (SPG) of member entities in the network, wherein each of the member entities is configured with a media access control (MAC) address locked to its own identity and a Internet protocol (IP) address linked to its MAC address;
establishing a secure handshake between at least a source member entity and a target member entity of the SPG by mutually authenticating the source member entity and the target member entity; and
securely transferring data from the source member entity to the target member entity.

2. The method of claim 1, wherein establishing the secure handshake further comprises:
exchanging public keys, where the public keys are selected from a public key infrastructure (PKI);
securely exchanging identities between the source member entity and the target member entity, wherein the identities are encrypted using said public keys;
exchanging challenge numbers to be used during the mutual authentication, wherein the challenge numbers are encrypted; and
by each member entity, verifying the received information and authenticating the identity of the member entity from which the information is received.

3. The method of claim 2, wherein the identity of an entity member comprises at least: the member entity's MAC addresses locked to its identity, the member entity's IP address linked to the MAC address, and the public key of the member entity.

4. The method of claim 2, wherein mutually authenticating the member entities further comprises:
by each member entity, verifying a received challenge number; and responding with a new challenge number.

5. The method in claim 2, wherein establishing the secure handshake further comprises: exchanging session keys between the source member entity and the target member entity.

6. The method of claim 1, wherein the network is at least one of: a local area network (LAN), an enterprise network, a metro area network (MAN), a wide area network (WAN), and the Internet.

7. The method of claim 1, wherein lower-layer level attacks include attacks performed using at least an Ethernet Layer.

8. The method of claim 7, wherein lower-layer level attacks include attacks performed using one of an Internet protocol (IP) Layer and a transport Layer.

9. The method of claim 1, wherein securely transferring data from the source member entity to the target member entity further comprises:
preparing an add-on to each data packet to be transferred;
combining the add-on with the data packet to form a new data packet;
encrypting the new data packet using a security key belonging to the target member entity to form an encrypted new data packet; and
sending the encrypted new data packet to the target member entity.

10. The method of claim 9, further comprises:
decrypting the received encrypted new data packet to extract the new data packet using the security key of the target member entity;
verifying the authenticity of the source member entity using the add-on included in the received new data packet;
accepting the received new data packet if the source member entity is verified; and
rejecting the received new data packet if the source member entity is not verified.

11. The method of claim 10, further comprises:
when the source member entity is not verified, requesting to resend the data packet from the source member entity; and informing a management entity of a possible attack.

12. The method of claim 9, wherein the add-on comprises a hash of at least a few bits of challenge response received and the data in the data packet to be sent by the source member entity.

13. The method in claim 9, wherein encrypting the new data packet is performed using a session key supplied by the target member entity during the secure handshake.

14. A non-transitory computer readable medium having stored thereon instructions for causing one or more processing units to execute the method according to claim 1.

15. A system for preventing lower-layer level attacks committed against entities in a network, comprising:
a plurality of member entities connected to a network, wherein the plurality of member entities are part of a secure peer group (SPG), each of the plurality of the member entities is configured with a media access control (MAC) address locked to its respective identity and with a unique identification;
a secure server for verifying legitimacy of a member entity requesting an Internet protocol (IP) address and upon verification assigning an IP address to the member entity, wherein the IP address is linked to a MAC address of the entity member;
at least a source member entity which is a member of the SPG; and
at least a target member entity which is a member of the SPG, wherein the source member entity establishes a secure handshake with the target member entity and securely transfers data to the target member entity.

16. The system of claim 15, wherein said network is one of: a local area network (LAN), a wide area network (WAN), a metro area network (MAN), and the Internet.

17. A method for providing packet level security during data transfer between a source member entity and a target member entity belonging to a secure peer group (SPG), comprising:
preparing an add-on to each data packet to be transferred;
combining the add-on with the data packet to form a new data packet;
encrypting the new data packet using a security key belonging to the target member entity to form an encrypted new data packet; and
sending the encrypted new data packet to the target member entity.

18. The method of claim 17, further comprises:
decrypting the received encrypted new data packet to extract the new data packet using the security key of the target member entity;
verifying the authenticity of the source target entity using the add-on included in the received new data packet;
accepting the received new data packet if the source member entity is verified; and
rejecting the received new data packet if the source member entity is not verified.

19. The method of claim 18, further comprises:
when the source member entity is not verified, requesting to resend the data packet from the source member entity and informing a management entity of a possible attack.

20. The method of claim 19, wherein each member entity is configured with a media access control (MAC) address locked to its own identity and an Internet protocol (IP) address linked to its MAC address.

21. The method of claim 17, wherein the add-on comprises a hash of at least a few bits of challenge response received during a mutual authentication process between the source member entity and the target member entity, and the data in the data packet to be sent by the source member entity.

22. The method in claim 17, wherein the security key is a public key selected from a public key infrastructure (PKI).

23. The method in claim 17, wherein encrypting the new data packet is performed using a session key supplied by the target member entity during the handshake process.

24. The method of claim 17, wherein combining the add-on with the data packet further comprises:
sending the add-on in a separate data packet.

25. The method of claim 17, further comprises: performing at least one of: signing, authenticating and encrypting the new data packet.

26. The method of claim 17, wherein the security key further includes a key selected from a group of keys or a mater key, wherein the group of keys or the mater key can be identified by a firewall in a network.
